(19) United States
(12) Patent Application Publication
(10) Pub. No.: US 2016/0364318 A1
(43) Pub. Date: Dec. 15, 2016

(54) ENHANCED BUG RESOLUTION

(71) Applicant: International Business Machines Corporation, Armonk, NY (US)

(72) Inventors: Yang Che, BEIJING (CN); Ying Chun Cheng, Beijing (CN); Xiao Ming Hu, Beijing (CN); Xin Peng Liu, Beijing (CN); RenFu Ma, Beijing (CN); Xi Juan Men, Beijing (CN); Lin He Wen, Beijing (CN); Yu Zhang, Beijing (CN)

(21) Appl. No.: 14/735,185

(22) Filed: Jun. 10, 2015

(51) Int. Cl. G06F 11/36

(52) U.S. Cl. CPC G06F 11/3664; G06F 11/362

(57) ABSTRACT

As disclosed herein a method, executed by a computer, includes launching a session corresponding to a test environment, saving a session context to provide a saved session context, and associating the saved session context with a defect record entered in a defect tracking system. The method further includes receiving a request to recreate the test environment using the saved session context and reconnecting to a session corresponding to the saved session context, in response to receiving the request to recreate the test environment. The method further includes terminating the session corresponding to the saved session context, in response to verifying resolution of an error identified in the defect record. A computer system, and a computer program product corresponding to the method are also disclosed herein.

### BACKGROUND

The present invention relates generally to bug detection and resolution, and more particularly to the efficiency of bug reproduction and resolution.

Many information technology (IT) projects use a defect tracking system to record software bugs (e.g., problems or errors). A defect tracking system is a software application that keeps track of reported software bugs discovered in development projects. The defect tracking system also provides a clear centralized place to manage defects records, including tracking the lifecycle of a defect record (i.e., tracking a defect record from creation through resolution, verification, and closure). A defect tracking system is usually considered a necessary component of a good software development infrastructure.

When a software tester encounters a bug in a product being tested, the tester may open up a defect record in a defect tracking system. The tester will enter information to describe the bug being reported to the defect tracking system. The entered information may include, for example, a screen shot of the error visible on a monitor, a written description of the error, a description of the test environment, privileges of the userid executing the test, the sequence of events or commands that lead to the error occurring, and any error logs that may have been generated. After the tester has submitted the defect in the defect tracking system, the defect is assigned to a developer for analysis and resolution. In many circumstances the developer will have to attempt to reproduce the error using the information entered in the defect by the tester. Once the error is reproduced, the developer can perform analysis, fix the error, and document the resolution in the defect record.

### SUMMARY

As disclosed herein a method, executed by a computer, includes launching a session corresponding to a test environment, saving a session context to provide a saved session context, and associating the saved session context with a defect record entered in a defect tracking system. The method further includes receiving a request to recreate the test environment using the saved session context and reconnecting to a session corresponding to the saved session context, in response to receiving the request to recreate the test environment. The method further includes terminating the session corresponding to the saved session context, in response to verifying resolution of an error identified in the defect record. A computer system, and a computer program product corresponding to the method are also disclosed herein.

### BRIEF DESCRIPTION OF THE DRAWINGS

FIG. 1 is a functional block diagram depicting a computing environment in accordance with an embodiment of the present invention;

FIG. 2 is a flowchart depicting a environment reproduction method, in accordance with an embodiment of the present invention;

FIG. 3A depicts example session context data resulting from initializing a test environment, in accordance with an embodiment of the present invention;

FIG. 3B depicts an example defect record, in accordance with an embodiment of the present invention;

FIG. 3C depicts example session context data after creation of a defect record, in accordance with an embodiment of the present invention; and

FIG. 4 is a block diagram depicting various components of one embodiment of a computer suitable for executing the methods disclosed herein.

### DETAILED DESCRIPTION

A software development life cycle (SDLC) is a process for planning, creating, testing, and deploying software with a goal of producing high quality software that meets or exceeds customer expectations. Bug detection and resolution is a critical portion of the SDLC. Testers perform tests on software and discover bugs (i.e., errors or problems) in the software. Once a tester discovers a bug, a defect is entered (i.e., the bug is documented documented) in a defect tracking system. The tester is required to provide detailed information corresponding to the bug. Included in the detailed information may be, for example, a screen shot of the error visible on a monitor, a written description of the error, a description of the test execution environment, the execution privileges of the userid executing the test, the sequence of events or commands that lead to the bug occurring, and any error logs that may have been generated. The purpose of providing the detailed information is to enable a developer to reproduce not only the bug, but also the environment that produced the bug.

In many instances, the developer is unable to reproduce the test environment (i.e., execution environment) that produced an error. The inability to reproduce the test environment may be due to insufficient information recorded in the defect record. The tester may not have accurately documented the event or command sequence that produced the bug, or didn't know the execution privileges of the userid executing the command(s) when the bug occurred. The developer may be able to contact the tester to try and obtain additional details, but it is unlikely the tester will recall details of a specific failed test case. Without the proper test environment, the developer may have to resort to other means of attempting to determine what may have caused the bug. The embodiments disclosed herein generally address and solve the above-described problems.

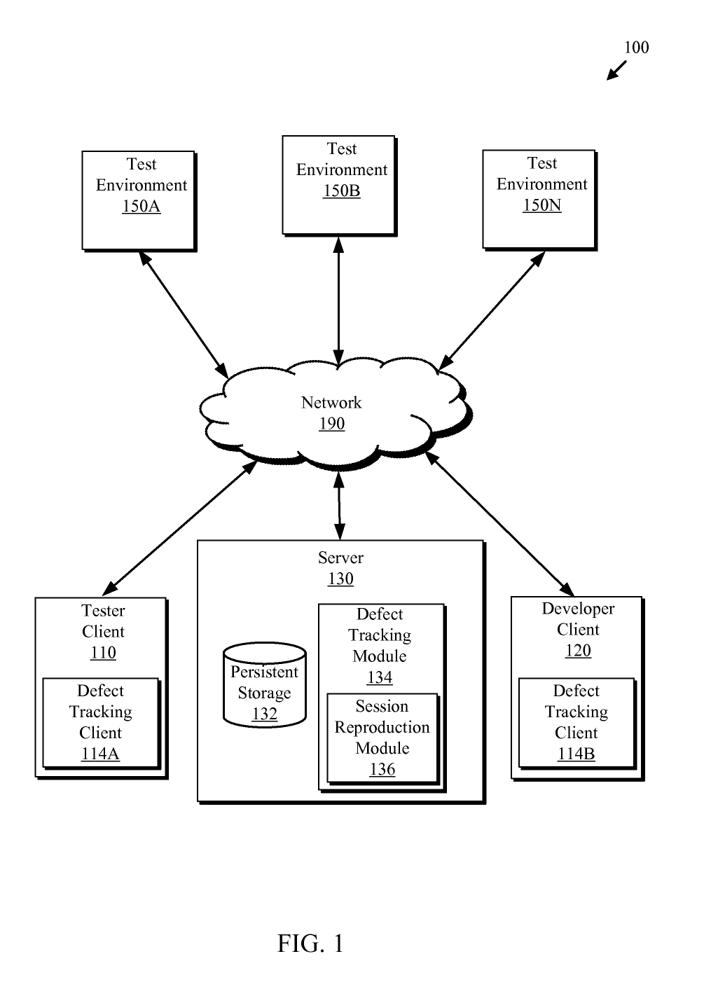

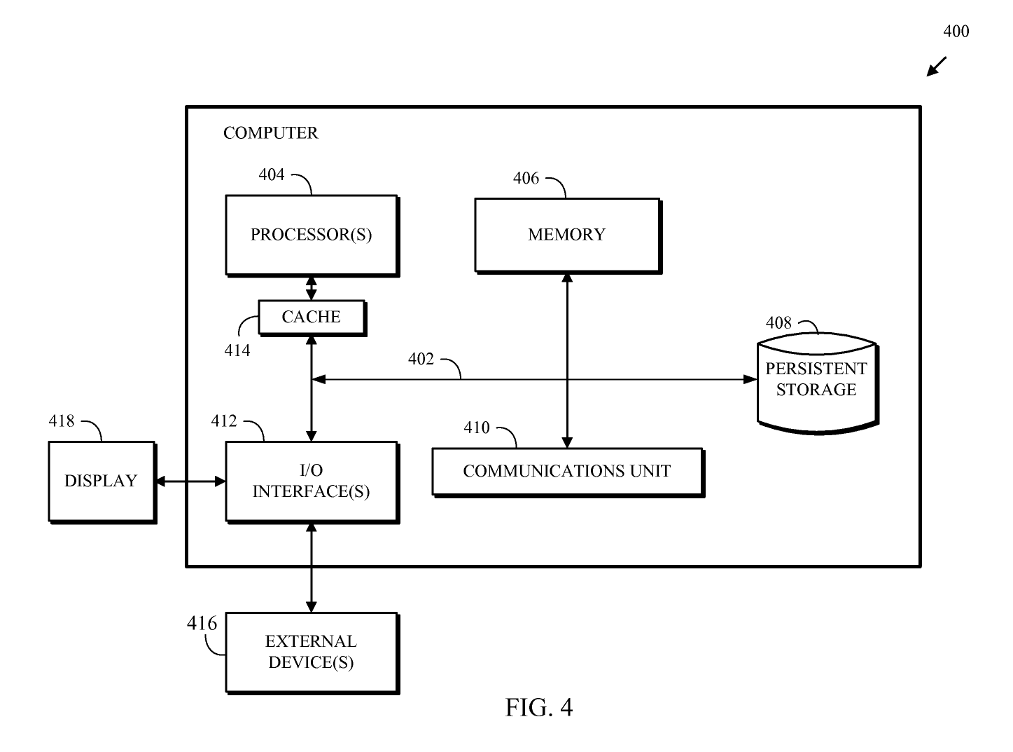

FIG. 1 is a functional block diagram depicting a computing environment 100 in accordance with an embodiment of the present invention. Computing environment 100 includes a tester client 110, a developer client 120, and a server 130 which can be smart phones, tablets, desktop computers, laptop computers, specialized computer servers, or any other computer systems known in the art. In some embodiments, tester client 110, developer client 120, and server 130 represent computer systems utilizing clustered computers and components to act as a single pool of seamless resources when accessed through a network 190. In general, tester client 110, developer client 120, and server 130 are representative of any electronic devices, or combination of electronic devices, capable of executing machine-readable program instructions, as described in greater detail with regard to FIG. 4.

As depicted, tester client 110 and developer client 120 include defect tracking clients 114A and 114B, respectively. A defect tracking client 114 may be configured to create a defect record, retrieve data corresponding to a specific defect record, and update a defect record. In some embodiments, defect tracking client 114A is configured to enable a tester to create a defect record that identifies a bug detected during a testing operation. The tester may also be able update any defect records created by the tester, as well as view all defect records. In other embodiments, defect tracking client 114B is configured to enable a developer to view all defect records and update defect records that are assigned to the developer. The developer may not be allowed to create new defect records. In another embodiment, defect tracking client 114 is configured to enable a single user (e.g., either a tester or a developer) to create defects and update any existing defect records.

As depicted, server 130 includes persistent storage 132 and defect tracking module 134. Defect tracking module 134 may be a software application capable of managing and maintaining reported problems (i.e., defect records) as they progress through states of a defect life cycle (e.g., new, assigned, active, test, verified, closed, reopened, deferred, rejected, and the like). A defect tracking system may include tester client 110, developer client 120, and defect tracking module 134 working together to collect and maintain defect information. Tester client 110 and developer client 120 may provide defect information (e.g., information about a bug) to defect tracking module 134. Defect tracking module 134 may store defect records and information corresponding to defect life cycle state on persistent storage 132.

As depicted, defect tracking module 134 includes session reproduction module 136. Session reproduction module 136 may be configured to perform the operations of environment reproduction method 200. A session is a semi-permanent interactive information interchange (e.g., dialogue or communication), between two or more computer devices.

Persistent storage 132 may be any non-volatile storage media known in the art. For example, persistent storage 132 can be implemented with a tape library, optical library, one or more independent hard disk drives, or multiple hard disk drives in a redundant array of independent disks (RAID). Similarly, data on persistent storage 132 may conform to any suitable storage architecture known in the art, such as a file, a relational database, an object-oriented database, and/or one or more tables.

As depicted, computing environment 100 also includes test environments 150A-150N. Test environments 150 can be desktop computers, laptop computers, specialized computer servers, or any other computer systems known in the art. Test environments 150 may be hardware and software provided in a dedicated infrastructure, provided as on-demand virtual machines, or obtained from shared computing resources such as cloud computing resources. In some embodiments, test environments 150 include dedicated hardware that is preconfigured with a runtime environment (e.g., operating system, memory, cpu, and the like) including the hardware or software to be tested. In other embodiments, test environment 150 is provisioned from a cloud on-demand service. In some embodiments, test environment 150 is dedicated to a single tester. In other embodiments, test environment 150 is configured to support and be accessed by multiple users (i.e. testers) performing one or more testing activities.

Defect tracking clients 114A and 114B communicate with Defect tracking module 134 and test environments 150A-150N over network 190. Network 190 can be, for example, a local area network (LAN), a wide area network (WAN) such as the Internet, or a combination of the two, and include wired, wireless, or fiber optic connections. In general, network 190 can be any combination of connections and protocols that will support communications between server tester client 110, developer client 120, server 130 and test environments 150 in accordance with an embodiment of the present invention.

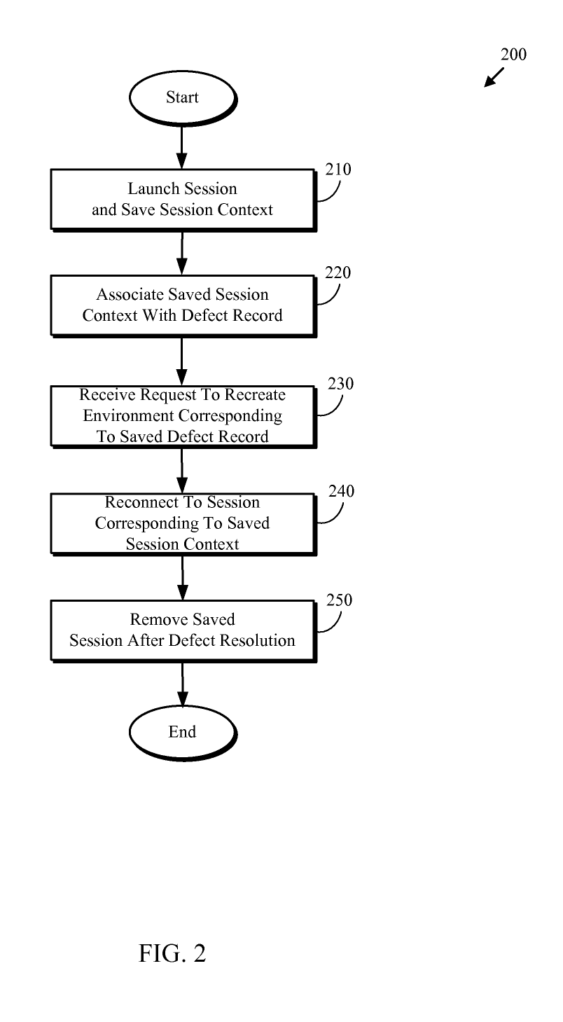

FIG. 2 is a flowchart depicting an environment reproduction method 200, in accordance with an embodiment of the present invention. As depicted, environment reproduction method 200 includes launching (210) a session, associating (220) a saved session context with a defect record, receiving (230) a request to recreate an environment, reconnecting (240) to a session, and terminating (250) a saved session. Environment reproduction method 200 enables a defect tracking system to reproduce a testing environment in which a bug was discovered. In addition to reproducing the environment, the commands executed in the original environment, leading up to the discovery of the bug, may be executed in the reproduced environment to assist in reproducing the bug. In some embodiments, environment reproduction method 200 is provided as an add-on or plugin to any compatible defect tracking module (e.g., defect tracking module 134). In other embodiments, environment reproduction method 200 is provided as callable user exit or stand-alone application.

Launching (210) a session may include defect tracking module 134 receiving a request from a client (e.g., testing client 110) to initialize a test session on one of test environments 150A-150N. In some embodiments, the environment is an LPAR (logical partition) on existing hardware and software infrastructure. In other embodiments, the environment has to be provisioned (i.e., prepared with appropriate systems, data and software,) from an on-demand cloud environment. An environment may be identified by a hostname (e.g., test.ibm.com).

Defect tracking module 134 may open a terminal emulation session using terminal emulation products known to those of skill in the art (e.g., Putty, SSH Secure Shell Client, XShell, SecureCRT, iTerm, PShell, Xmanager and the like). After a terminal emulation session is established, a login session may be created using login credentials (e.g., userid and password) provided at the time the request to launch a session was initiated. After the terminal session and login session have been successfully created, defect tracking module 134 may record (e.g., save) a session context that identifies the host, terminal session and login session corresponding to the current environment. Defect tracking module 134 may save the current session context on persistent storage (e.g., persistent storage 132) as an entry in a database, in a file, or any storage format familiar to those of skill in the art. The saved session context record may include information required to reproduce (i.e., reconnect to) the session, such as, but not limited to, a Session ID, a Hostname, a Login, a Password, a Login Command, and an Access Key.

Associating (220) a saved session context record with a defect record may include defect tracking module 134 receiving a request from a client (e.g., tester client 110), using a defect tracking client (e.g., defect tracking client 114A), to create a defect record on the defect tracking system. In addition to creating the defect record, defect tracking module 134 may update the saved session context record corresponding to the current test environment to reference the newly created defect record, thus associating the newly created defect record and a saved session context record with each other. Additionally, the session identified in the saved session context record remains attached to the host, as an active session, until the bug is resolved. In some embodiments, all state information corresponding to the session identified in the saved session context record is saved to persistent storage, enabling the session to be terminated and recreated at a later time. In other embodiments, if a test duration ends (e.g., the tester logs out) without creating defect record, then the session and the saved session context record corresponding to the test session are both deleted.

Receiving (230) a request to recreate an environment may include defect tracking module 134 receiving a request from a client (e.g., developer client 120) using a defect tracking client (e.g., defect tracking client 114B), to recreate an environment corresponding to a saved session context. In some embodiments, a defect ID (e.g., a unique number assigned to a specific defect record) is provided as a key to identify the saved session context record that corresponds to the requested environment. Upon receiving the request, defect tracking module 134 may retrieve the saved session context record that has been associated with the defect ID provided in the request. In other embodiments, the request provides a saved session context ID that identifies the saved session context record that corresponds to the requested environment.

Reconnecting (240) to a session may include defect tracking module 134 determining the hostname of the test environment (e.g., test environment 150) on which the target session resides. In some embodiments, the hostname information is retrieved from a hostname field in the saved session context record. In other embodiments, the hostname information is embedded in the Session ID string and can be extracted from the session ID string using operation familiar to those of skill in the art. In some embodiments, connecting to an existing session is accomplished using the session identifier from the Session ID field in the saved session context record. In other embodiments, a command that connects to the existing session on a host is available in the saved session context record. Additionally, the login information is available from the Login, Password, and Login Command fields of the saved session context record.

Once the session is successfully reconnected and the user is logged in, the environment should be equivalent to the environment that produced the bug reported by the defect record associated with the current session. Using commands and operations familiar to those of skill in the art, a developer may be able to: (i) export environment variables from the tester's environment to the reproduced environment, (ii) obtain a list of the operations (e.g., commands) performed by the tester and re-execute the commands in the reproduced environment.

Terminating (250) a saved session may include a defect record reaching a lifecycle state indicating that the bug identified in the defect record has been resolved. After a bug is resolved, defect tracking module 134 may terminate the saved session (e.g., detach the saved session from the host). In some embodiments, defect tracking module 134 removes (i.e., deletes) the saved session context record. In other embodiments, a saved session can be referenced by more than one saved session context record and cannot be terminated (e.g., detached) until all references have been removed. In some embodiments, a state of ‘verified’ indicates the bug corresponding to the defect record is resolved and the saved session is terminated. In other embodiments, a state of ‘closed’ indicates the bug corresponding to the defect record is resolved and the saved session is terminated.

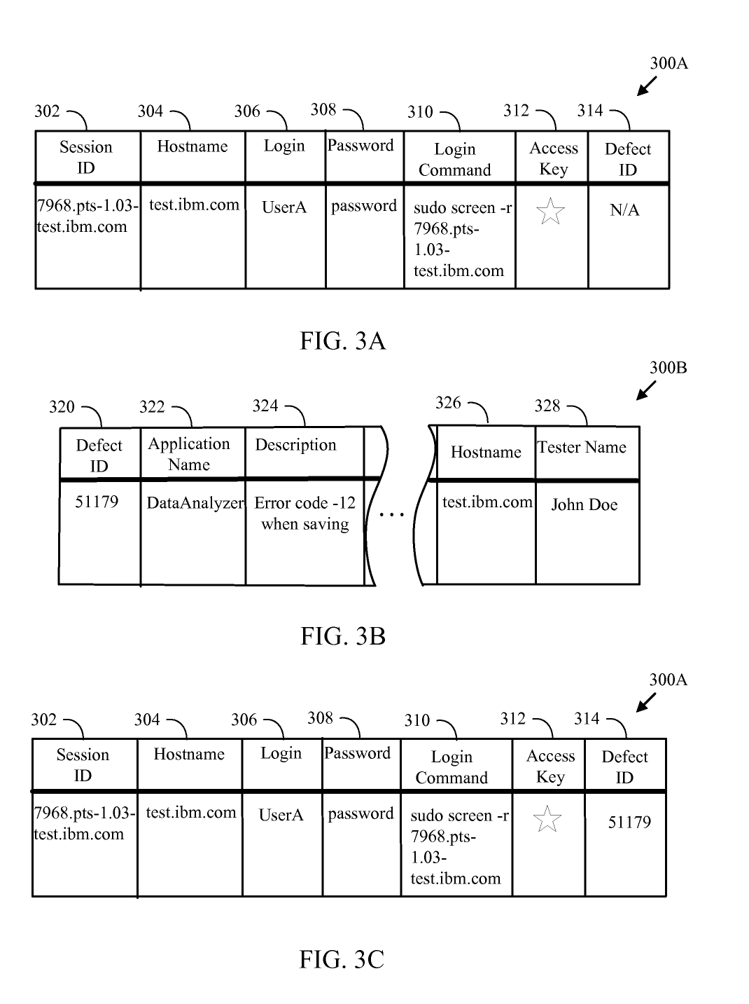

FIGS. 3A-3C depict example data consisting of an initialized saved session context record 300A, an example defect record 300B, and the saved session context record 300A after creation of the defect record 300B, in accordance with an embodiment of the present invention. FIGS. 3A-3C provide only an illustration of one example and do not imply any limitations with regard to different record format, record content, data format, or data format that may or may not be included in other embodiments.

FIG. 3A depicts example saved session context record 300A that is initialized (i.e., created) when a defect tracking module (e.g., defect tracking module 134) initializes a test session. When initialized, saved session context record 300A includes data fields to store information required to identify a session and potentially reconnect to the identified session. When initialized, saved session context record 300A contains fields: (i) Session ID 302—a unique identifier corresponding to a saved session, (ii) Hostname 304—the hostname of the computing device containing the saved session, (iii) Login 306—the userid for the logged-in user, (iv) Password 308—the password for the logged-in user, (v) Login Command 310—the command to reconnect to the saved session, (vi) Access Key 312—a shared key corresponding the saved session enabling shared key authentication with the shared session, and (vii) Defect ID 314—the unique identifier of a defect record associated with the saved session. When defect tracking module 134 initializes a test session, it also creates session context record 300, filling in data fields 302—312 and leaving Defect ID 314 empty.

FIG. 3B depicts example defect record 300B that may be created by a defect tracking module (e.g., defect tracking module 134) when a tester enters information corresponding to a bug. Defect record 300B contains fields: (i) Defect ID 320—the unique identifier of a defect record that identifies and documents a bug encountered during a test session, (ii) Application Name 322—a name or identifier corresponding where the bug was encountered, (iii) Description 324—a text description of the bug, (ii) Hostname 326—the hostname of the computing device where the bug was discovered, and (iv) Tester Name—the name of that discovered the bug. Example defect record 300B identifies only a subset of the information that may be collected and stored in a defect record. Example defect record 300B may contain a plurality of required and optional data fields (not shown) such as, but not limited to, fields to assist with bug reproduction, bug resolution, and analytical analysis (e.g., causal analysis, bug injection point analysis, resolution analysis, and the like). In the current example, Defect ID 320 includes unique identifier 51179. The bug corresponding to defect 51179 was encountered when testing in the session identified by saved session context record 300A.

FIG. 3C depicts example saved session context record 300A after creation of defect record 300B. When a defect tracking module (e.g., defect tracking module 134) creates defect record 300B, it may also associate saved session context record 300A and defect record 300B with each other. As depicted in FIG. 3C, Defect ID 314 has been updated to contain the unique identifier (i.e., 51179) of the defect record corresponding to defect record 300B, thus associating saved session context record 300A with defect record 300B. In some embodiments, defect record 300B contains a Session field to be populated with a unique identifier corresponding to saved session context record 300A, thus associating defect record 300B with saved session context record 300A.

When a developer attempting to resolve the bug identified by defect record 300B (i.e., defect record 51179), the developer may desire to recreate the test environment in which the bug occurred. To do so, the defect tracking module (e.g., defect tracking module 134) may search for, and retrieve the saved session context record associated with defect record 51179 (i.e., saved session context record 300A). Upon retrieving saved session context record 300A, defect tracking module 134 may recreate the test environment using the information contained in saved session context record 300A.

When the lifecycle state of defect record 300B indicates the resolution to the bug has been verified (e.g., a state of verified or closed), defect tracking module 134 may indicate the session is no longer needed. In some embodiments, defect tracking module 134 terminates the session (e.g., detaches or removes the session from the host). In other embodiments, defect tracking module 134 clears any fields in saved session context record 300A and/or defect record 300B associating the two records with each other. In another embodiment, defect tracking module 134 removes (i.e., deletes) saved session context record 300A.

FIG. 4 depicts a block diagram of components of a computer system 400, which is an example of systems such as tester client 110, developer client 120 and server 130 within computing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

Tester client 110, developer client 120 and server 130 include processor(s) 404, cache 414, memory 406, persistent storage 408, communications unit 410, input/output (I/O) interface(s) 412 and communications fabric 402. Communications fabric 402 provides communications between cache 414, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM). In general, memory 406 can include any suitable volatile or non-volatile computer readable storage media. Cache 414 is a fast memory that enhances the performance of processor(s) 404 by holding recently accessed data, and data near recently accessed data, from memory 406.

Program instructions and data used to practice embodiments of the present invention, e.g., environment reproduction method 200 are stored in persistent storage 408 for execution and/or access by one or more of the respective processor(s) 404 via cache 414. In this embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including resources of tester client 110, developer client 120 and server 130. In these examples, communications unit 410 includes one or more network interface cards. Communications unit 410 may provide communications through the use of either or both physical and wireless communications links. Program instructions and data used to practice embodiments of environment reproduction method 200 may be downloaded to persistent storage 408 through communications unit 410.

I/O interface(s) 412 allows for input and output of data with other devices that may be connected to each computer system. For example, I/O interface(s) 412 may provide a connection to external device(s) 416 such as a keyboard, a keypad, a touch screen, a microphone, a digital camera, and/or some other suitable input device. External device(s) 416 can also include portable computer readable storage media such as, for example, thumb drives, portable optical or magnetic disks, and memory cards. Software and data used to practice embodiments of the present invention can be stored on such portable computer readable storage media and can be loaded onto persistent storage 408 via I/O interface(s) 412. I/O interface(s) 412 also connect to a display 418.

Display 418 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
launching a terminal emulation session corresponding to a test environment;
saving a session context to provide a saved session context;
associating the saved session context with a defect record entered in a defect tracking system;
receiving a request to replicate the test environment using the saved session context;
reconnecting to the terminal emulation session corresponding to the saved session context, responsive to receiving the request to replicate recreate the test environment; and
terminating the terminal emulation session corresponding to the saved session context, responsive to verifying resolution of an error identified in the defect record.

2. The method of claim 1, wherein the terminal emulation session corresponding to the saved session context is not terminated if the saved session context is associated with the defect record.

3. The method of claim 1, wherein the terminal emulation session is terminated, and the saved session context is deleted if a test duration ends without creating the defect record.

4. The method of claim 1, wherein the defect record comprises the error discovered in the test environment.

5. The method of claim 1, wherein the defect tracking system comprises one or more defect clients providing defect information and the defect tracking module to maintain the defect information.

6. The method of claim 1, wherein the saved session context is saved on persistent storage corresponding to the defect tracking module.

7. The method of claim 1, wherein the saved session context comprises a record stored on persistent storage accessible by the defect tracking module.

8. A computer program product comprising:
one or more computer readable storage media and program instructions stored on the one or more computer readable storage media, the program instructions comprising instructions to:
launch a terminal emulation session corresponding to a test environment;
save a session context to provide a saved session context;
associate the saved session context with a defect record entered in a defect tracking system;
receive a request to replicate the test environment using the saved session context;
reconnect to the terminal emulation session corresponding to the saved session context responsive to receiving the request to replicate the test environment; and
terminate the terminal emulation session corresponding to the saved session context responsive to verifying resolution of an error identified in the defect record.

9. The computer program product of claim 8, wherein the terminal emulation session corresponding to the saved session context is not terminated if the saved session context is associated with the defect record.

10. The computer program product of claim 8, wherein the terminal emulation session is terminated, and the saved session context is deleted if a test duration ends without creating the defect record.

11. The computer program product of claim 8, wherein the defect record comprises the error discovered in the test environment.

12. The computer program product of claim 8, wherein the defect tracking system comprises one or more defect clients providing defect information and a defect tracking module to maintain the defect information.

13. The computer program product of claim 8, wherein the saved session context is saved on persistent storage corresponding to the defect tracking module.

14. The computer program product of claim 8, wherein the saved session context comprises a record stored on persistent storage accessible by the defect tracking module.

15. A computer system comprising:
one or more computer processors;
one or more computer readable storage media;
program instructions stored on the computer readable storage media for execution by at least one of the computer processors, the program instructions comprising instructions to:
launch a terminal emulation session corresponding to a test environment;
save a session context to provide a saved session context;
associate the saved session context with a defect record entered in a defect tracking system;
receive a request to replicate the test environment using the saved session context;
reconnect to the terminal emulation session corresponding to the saved session context responsive to receiving the request to replicate the test environment; and
terminate the terminal emulation session corresponding to the saved session context responsive to verifying resolution of an error identified in the defect record.

16. The computer system of claim 15 wherein the terminal emulation session corresponding to the saved session context is not terminated from a host if the saved session context is associated with the defect record.

17. The computer system of claim 15, wherein the terminal emulation session is terminated, and the saved session context is deleted if a test duration ends without creating the defect record.

18. The computer system of claim 15, wherein the defect record comprises the error discovered in the test environment.

19. The computer system of claim 15, wherein the defect tracking system comprises one or more defect clients providing defect information and the defect tracking module to maintain the defect information.

20. The computer system of claim 15, wherein the saved session context comprises a record stored on persistent storage accessible by the defect tracking module.
